(19) United States
(12) Patent Application Publication
(10) Pub. No.: US 2024/0419205 A1
(43) Pub. Date: Dec. 19, 2024

(54) OPTICAL COMPUTING DEVICE

(71) Applicant: BRITISH TELECOMMUNICATIONS PUBLIC LIMITED COMPANY, London, Greater London (GB)

(72) Inventor: Robert HERCOCK, London, Greater London (GB)

(21) Appl. No.: 18/719,144

(22) PCT Filed: Nov. 8, 2022
(86) PCT No.: PCT/EP2022/081091

§ 371 Date: Jun. 12, 2024

(30) Foreign Application Priority Data
Dec. 14, 2021 (GB) 2118059.1

(51) Int. Cl. G06E 3/00; G02F 1/13; G06N 3/067; H04L 9/06

(52) U.S. Cl. CPC G06E 3/005; G02F 1/1326; G06N 3/0675; H04L 9/0618

(57) ABSTRACT

An optical computing device is described which has a plurality of light sources, each light source arranged to generate a photon stream, whereby the plurality of photon streams together represent a data input to be processed. There is a plurality of modulators, each modulator arranged to modulate a photon stream received from one of the light sources, each modulator producing a caustic wavefront. The modulators are positioned relative to one another such that there is interference between the caustic wavefronts. A controller controls the modulators in order to control the interference between the caustic wavefronts such that there is computation of the data input. An output stage outputs light resulting from the interference between the caustic wavefronts, the output light representing the result of optical computation of the data input.

### BACKGROUND

Optical computing devices typically attempt to replace silicon transistors by equivalent optical transistors.

The embodiments described below are not limited to implementations which solve any or all of the disadvantages of known optical computing devices.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is an optical computing device comprising:
a plurality of light sources, each light source arranged to generate a photon stream, whereby the plurality of photon streams together represent a data input to be processed;
a plurality of modulators, each modulator arranged to modulate a photon stream received from one of the light sources, each modulator producing a caustic wavefront; and wherein the modulators are positioned relative to one another such that there is interference between the caustic wavefronts;
a controller for controlling the modulators in order to control the interference between the caustic wavefronts such that there is computation of the data input; and
an output stage to output light resulting from the interference between the caustic wavefronts, the output light representing the result of optical computation of the data input. In this way an effective optical equivalent of a silicon transistor is provided so that data processing is achieved in the optical domain. By using caustic wavefronts which interfere with one another it is possible to have an equivalent of a silicon transistor. The speed of operation is optical speed and as explained in more detail below the technology is scalable to achieve huge amounts of computation for applications such as neural networks, encryption and others whilst consuming low power as compared with alternatives such as using graphical processing units.

Preferably the modulators are controlled by a digital computer in order to control constructive and destructive interference between the caustic wavefronts such that there is computation of the data input. Controlling the modulators in this manner gives fine grained control which is efficient.

Preferably the output stage is configured to send feedback to the controller and where the controller takes into account, as part of controlling the modulators, one or more of: the feedback, time and a shape of a light caustic that evolves over time. By taking into account feedback and/or time and shape of a light caustic it is possible to improve accuracy of computation.

Preferably the plurality of light sources are arranged in an array and the plurality of modulators are arranged in a corresponding array, and wherein the light sources are controllable to vary frequency and/or intensity of individual ones of the photon streams. By varying frequency and/or intensity it is possible to scale up the amount of computation.

Preferably the plurality of modulators is a first layer of modulators and wherein the optical computing device further comprises at least one further layer of modulators in series with the first layer of modulators, and wherein the further layer of modulators receives input comprising light from the first layer of modulators and produces output which is the output light. By using a plurality of layers of modulators the amount of computation achieved is increased.

In an example, the optical computing device further comprises a plurality of filter layers, and wherein the first layer of modulators and a corresponding filter layer computes a first layer of a neural network and each further layer of modulators and corresponding filter layer computes a further layer of a neural network; and where the filter layers are controllable by the controller in order to train the neural network. In this way a hardware neural network is provided which consumes low power and which operates at optical speed.

Preferably at least some of the modulators comprise refractive transparent material. This gives a practical way to implement the modulators which is effective.

In various examples, the at least some modulators are one or more of: a liquid in a case driven to vibrate so as to set up standing waves in the liquid; a glass lens driven so that a relative position of the lens with respect to the light sources is changeable. These provide practical ways of implementing modulators which give fine grained modulator control.

In various examples, at least some of the modulators comprise reflective surfaces. Using reflective surfaces is a cost-effective way to implement modulators.

For example, the at least some modulators are either a deformable reflective surface or a micro-mirror chip. Using micro-mirror chips is straightforward since these are available off the shelf.

In an example, at least some of the modulators are transparent liquid crystal displays configured to product a variable diffraction grating effect. Using liquid crystal displays gives a compact solution.

Preferably the output stage comprises any one or more of: at least one image capture device to capture the output light; an optic fibre for transmitting the output light to another entity. Using an image capture device gives efficiency and is straightforward since image capture devices are readily commercially available.

Preferably the plurality of optical sources, comprises a first plurality of optical sources and a second plurality of optical sources; and wherein the plurality of modulators, comprises a first plurality of modulators in series with the first plurality of optical sources, and a second plurality of modulators in series with the second plurality of optical sources, such that in use, computation via the first plurality of modulators occurs in parallel with computation via the second plurality of modulators. In this way the device is scalable to compute large amounts of data processing.

In various examples the optical sources are pulsed and the modulators are controlled taking into account a timing of the pulsed optical sources. Using pulsed sources gives scalability.

Preferably the controller controls the modulators by setting values of parameters of the modulators and wherein the parameter values are a secret key of a block cipher such that the output light is an encrypted representation of the data input. This gives an effective encryption means.

In various examples there is a method comprising:
operating a plurality of light sources, each light source generating a photon stream, whereby the plurality of photon streams together represent a data input to be processed;
using a plurality of modulators, each modulator modulating a photon stream received from one of the light sources, each modulator producing a caustic wavefront; and
controlling the modulators in order to control constructive and destructive interference between the caustic wavefronts such that there is computation of the data input. This gives an efficient, effective way of optical computation.

In various examples, the controller controls the modulators by setting values of parameters of the modulators, the values being a secret key of a block cipher, and wherein light output from the modulators after the constructive and destructive interference is an encryption of the data input according to the block cipher. In this way encryption is achieved in an efficient manner at optical speed.

A method of decrypting light which represents encrypted data, the method comprising, using the controller to set values of the parameters of the modulators in order to reverse the effect of the secret key; inputting the light which represents the encrypted data to the modulators such that light emitted from the modulators represents the decrypted data. Thus decryption is achieved in an efficient manner at optical speed.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an optical computing device;

FIG. 2 is a schematic diagram of an optical computing device having a plurality of modulator arrays arranged in series;

FIG. 3 is a schematic diagram of an optical computing device having a plurality of modulator arrays arranged in parallel;

FIG. 4 is a schematic diagram of part of an optical computing device showing a light source array and a modulator array;

FIG. 5 is a flow diagram of a method of calibration of an optical computing device;

FIG. 6A is a flow diagram of a method of encrypting data using an optical computing device;

FIG. 6B is a flow diagram of a method of decrypting data using an optical computing device.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Optical computing devices typically attempt to replace silicon transistors by equivalent optical transistors. Doing so is not straightforward and has not been commercially successful since silicon transistors are extremely cost effective and workable. The inventor has recognized that caustic wavefronts can be used to create optical transistors. The inventor has devised an optical computing device which creates caustic wavefronts and uses them to carry out computation. The optical computing device gives particular efficiencies in fields such as neural networks, cryptography and others where silicon transistors experience limitations.

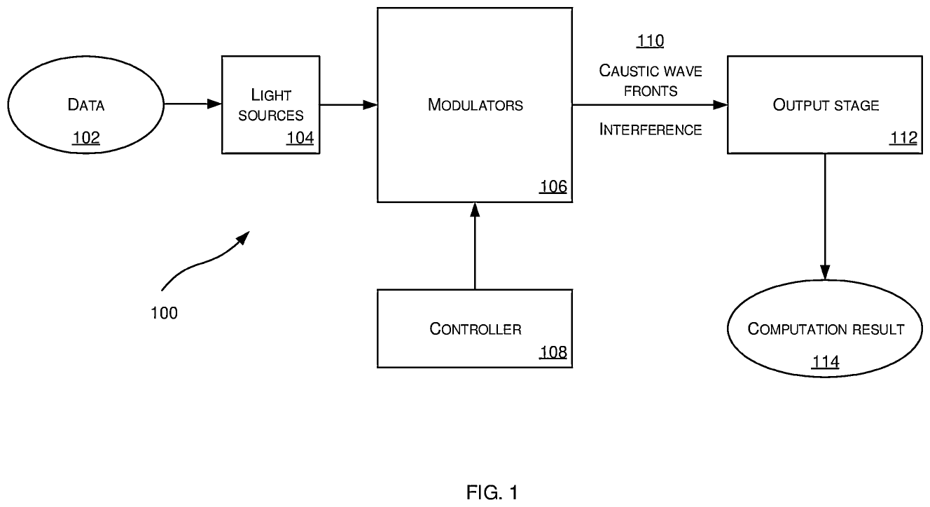

FIG. 1 is a schematic diagram of an optical computing device 100 comprising a plurality of light sources 104, a plurality of modulators 106, a controller 108 and an output stage 112.

The light sources are light emitting diodes (LEDs) or any other light sources which emit streams of photons. In some but not all embodiments individual ones of the light sources are controllable in order to control a frequency of the photon stream emitted by the light source, and or to control an intensity of the photon stream emitted by the light source. The light sources emit streams of photons which together represent data 102 to be processed by the optical computing device 100.

There is a plurality of modulators 106. In some but not all embodiments there is one modulator per light source. Each modulator is arranged to modulate light from one or more of the light sources 104 in order to produce a caustic wavefront 110. A caustic wavefront is an envelope of light rays refracted or reflected by a curved surface. Caustics are visible as patches of light or their bright edges such as often seen when looking at shallow water illuminated by the sun.

Each modulator is controllable by controller 108 which is a computing-based device such as a personal computer, microprocessor or any other computing-based device, in order to control characteristics of the caustic wavefront created by the modulator in a known manner. There are numerous ways to implement the modulators as explained in more detail below.

The modulators are positioned with respect to one another so that the caustic wavefronts 110 potentially interfere with one another as a result of constructive or destructive interference. As a result of the interference there is processing of the data 102. The controller is able to anticipate how the constructive or destructive interference will occur and so is able to control the modulators in order to create precise, specified, caustic patterns.

An output stage 112 outputs light from the caustic wavefronts 110 after the interference. The output stage 112 thus outputs computation results 114 which are the result of processing the data 102.

In some cases the output stage 112 comprises one or more image capture devices which capture and store one or more images of the output light. Additionally or alternatively the output stage comprises optic fibre to transmit the output light to another location for ongoing processing and/or measurement.

In an example a modulator is a transparent liquid in a transparent case where the case is driven (by the controller 108) to vibrate so as to set up one or more standing waves in the liquid. When the light from one or more of the light sources 104 passes through the case of liquid the light is refracted by varying amounts according to the changing density of liquid in the case and thus a caustic wavefront is output. One embodiment uses a thin liquid film layer in a transparent case, which is then vibrated at a determined frequency, (ultrasound ˜40 Khz is one viable frequency range). The resulting standing waves in the liquid are precisely tuned to create a caustic wavefront from the incoming light wave. By varying the drive frequency, the structure and shape of the caustic is determined. A motor drive system for driving the vibration of the case is used.

In an example a modulator is a glass lens driven by the controller 108 so that a relative position of the lens with respect to the light sources 104 is changeable. When the light from one or more of the light sources 104 passes through the lens the light is refracted by varying amounts according to the changing relative position and thus a caustic wavefront is output.

In an example at least some of the modulators comprise reflective surfaces such as a deformable reflective surface or a micro-mirror chip also referred to as a digital micromirror device. The controller 108 is arranged to individually control rotation of the micro mirrors such that a caustic wavefront is produced. In the case of a reflecting modulator, the incoming wave front is reflected from an adaptive surface. This reduces chromatic aberration, although the overall optical path across multiple modulators is folded.

In another example at least some of the modulators are transparent liquid crystal displays configured to product a variable diffraction grating effect. This is an example of using variable micro-fringes within a transparent substrate. Creating a variable diffraction grating effect in the substrate results in a light caustic output. Fast switching speeds are thereby facilitated. For example, the gratings are made from transparent LCD layers, with electronic switching of the grating patterns. LCD structures (as crystals) are used to control the phase and polarization of the caustic wavefronts in some cases.

In some examples all the modulators 106 are of the same type however, it is not essential to do so. In some cases the modulators 106 are a combination of one or more of: refractive modulators, reflective modulators, transparent liquid crystal displays.

The optical computing device of FIG. 1 operates at optical speed which is beneficial for applications where reduced latency is critical such as safety critical systems, robotic control systems, self-driving vehicles and similar. The speed of operation is limited only by the speed of control of the modulators 106 by the controller 108.

The optical computing device of FIG. 1 enables a mixed analog and digital data processor to be deployed. The input to the optical computing device may be optical or digital and the output is optical. Thus the device interfaces well with existing optical and digital systems.

The optical computing device of FIG. 1 is robust to electrical noise and radiation.

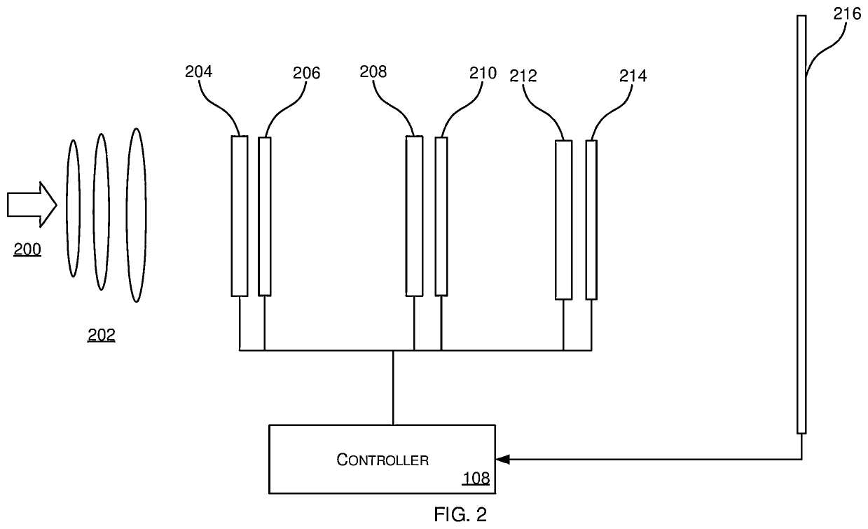

FIG. 2 is a schematic diagram of an optical computing device having a lens focusing array 202, three modulator arrays 204, 208, 212 arranged in series, three filters 206, 210, 214, one per modulator array, an image capture device 216 which in this example is a charge-coupled device (CCD) sensor array, and a controller 108. The controller is connected to each of the modulator arrays, filters and to the CCD sensor array.

In the example of FIG. 2 light from one or more light sources 200 represents data to be processed. The light passes through a lens focusing array 202 and enters a first plurality of modulators 204 also referred to as a first layer of modulators 204. The first layer of modulators 204 is a planar, two-dimensional array of modulators in some cases although that is not essential. The modulators are any one or more of the types of modulators described above with reference to FIG. 1 and are controlled by controller 108. The modulators modulate the light and create a plurality of caustic wavefronts which are not visible in FIG. 2. The caustic wavefronts pass through filter 206 which selectively reduces the intensity of individual ones of the caustic wavefronts by different amounts. The filter 206 is controlled by controller 108. The caustic wavefronts continue to propagate towards CCD sensor array 216 and experience constructive and/or destructive interference with one another due to their proximity.

The propagating caustic wavefronts reach a second modulator array 208 also referred to as a modulator layer. The second modulator array 208 modulates the caustic wavefronts in a manner controlled by controller 108 and the intensity of the caustic wavefronts is controlled using filter 210 which is also controlled by controller 108. The caustic wavefronts emitted from filter 210 continue to propagate and experience constructive and/or destructive interference with respect to one another. The caustic wavefronts reach third modulator array 212.

The third modulator array 212 modulates the caustic wavefronts in a manner controlled by controller 108 and the intensity of the caustic wavefronts is controlled using filter 214 which is also controlled by controller 108. The caustic wavefronts emitted from filter 214 continue to propagate and experience constructive and/or destructive interference before reaching CCD sensor array 216.

The CCD sensor array 216 captures an image of the caustic wavefronts and sends the image to the controller 108 for use in controlling the modulators. The image is stored and sent to other computing entities in some cases as the image is the computation result 114 of FIG. 1.

The arrangement of FIGS. 1 and 2 is scalable by adding more layers of modulators in the series so as to carry out more computational steps on the data.

The arrangement of FIGS. 1 and 2 is scalable by adding more modulators in each modulator array.

The arrangement of FIGS. 1 and 2 is scalable by using frequency modulation of the light source. Light of a first frequency is used to process data using the optical computing device whilst at the same time light of a second frequency is used to process different data using the same optical computing device.

The arrangement of FIGS. 1 and 2 is scalable by using time division multiplexing. The light from the light source(s) is pulsed and the controller is aware of the pulse timing. First data is processed using a first series of pulses and second data is processed using a second series of pulses interleaved with the first series.

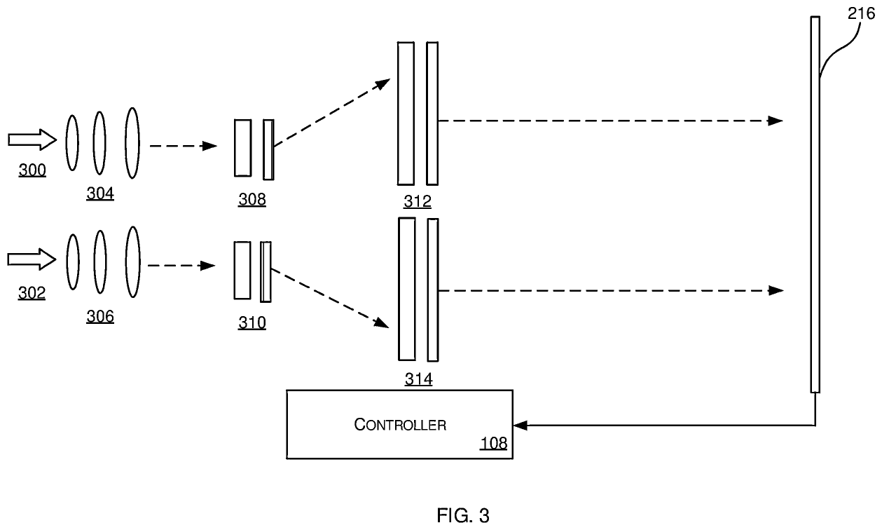

In FIG. 1 and FIG. 2 a light source and modulator in series is referred to as a stage. The arrangement of FIG. 1 and FIG. 2 is scalable by using more than one stage in parallel as illustrated in FIG. 3.

The technology is scalable by using combinations of one or more of: adding more layers of modulators in series, adding more modulators in each modulator array, using frequency modulation of the light source, using time division multiplexing of the light source, using more than one stage in parallel.

FIG. 3 is a schematic diagram of an optical computing device having a plurality of modulator arrays arranged in parallel. In FIG. 3 there is a first stage comprising a light source 300, a lens focusing array 304, an initial modulator array and filter 308 and a subsequent modulator array and filter 312. There is also a second stage in parallel with the first stage. The second stage comprises a second light source 302, a second lens focusing array 306, a second initial modulator array and filter 310 and a second subsequent modulator array and filter 314.

In FIG. 3 there is a single image capture device 216 and a single controller 108 for controlling the modulators and filters. The light in the first stage is independent of the light in the second stage. That is there is generally little or no constructive or destructive interference between caustic wavefronts of the first and second stages. Caustic wavefronts in the first stage experience interference between themselves during propagation from modulator array 308 to modulator array 312 and also between modulator array 312 and the image capture device 216.

Caustic wavefronts in the second stage experience interference between themselves during propagation from modulator array 308 to modulator array 312 and also between modulator array 312 and the image capture device 216.

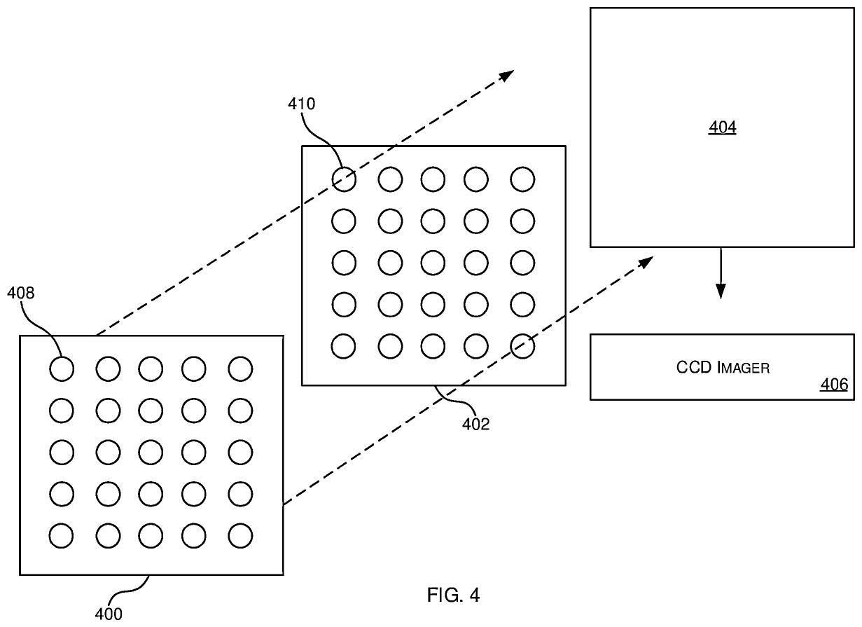

FIG. 4 is a schematic diagram of part of an optical computing device showing a light source array 400, a modulator array 402, a projection screen 404 and a CCD imager 406. Together the light source array 300, modulator array 402 and projection screen 404 form a three-dimensional (3D) structure. The base layer holds an array of light sources. These are tuneable multi-spectrum LED lights, or LED laser diodes although other light sources are used in other embodiments.

The next N layers are a 2D array of modulator units. These are built using any of the stated modulator options, depending on the specific application. FIG. 4 shows a single layer of modulators 402, but a physical implementation would generally have N layers where N is a positive integer greater than 1.

A final layer in the structure is either an array of CCD type image capture elements, or a translucent projection screen 404, in which case a single CCD imager 406 is placed above the screen to capture the outputs, as a single image. At full speed, the output is a video frame rate sequence, such as over 15 frames/second. The controller has video capture capability to manage the input from the CCD imager 406.

In operation a data array is input to the light source array 400 and used to control the light intensity and optionally wavelength. The resulting light field passes through the first modulator layer 402, and this creates a new complex light field that passes through successive layers of modulators.

The final light field from the end modulator layer then impacts the projection screen 404 and creates an output image. This is captured in real time by the CCD imager 406 and passed to the controller 108 to control each layer of modulators.

Once the required computation has completed, the output is interpreted by the controller (by converting from optical to digital form) and a response generated for a user, or used in further computational processing.

The arrangement of FIG. 4 is modified in some embodiments by using folded path optics through the use of mirrors and/or prisms in order to achieve a compact apparatus.

In some examples, each caustic wavefront has a distinct 3D shape (such as swallowtail, elliptic, fold, cusp, hyperbolic umbilic, elliptic umbilic) that evolves over time. This temporal reshaping of each caustic wavefront is taken into account by the controller 108 in some examples, in order to achieve additional inferencing effects. For example, to achieve a memory effect, or time delay function. The controller knows the 3D shape of individual ones of the caustic wavefronts and is able to use this knowledge to influence how it controls the modulators.

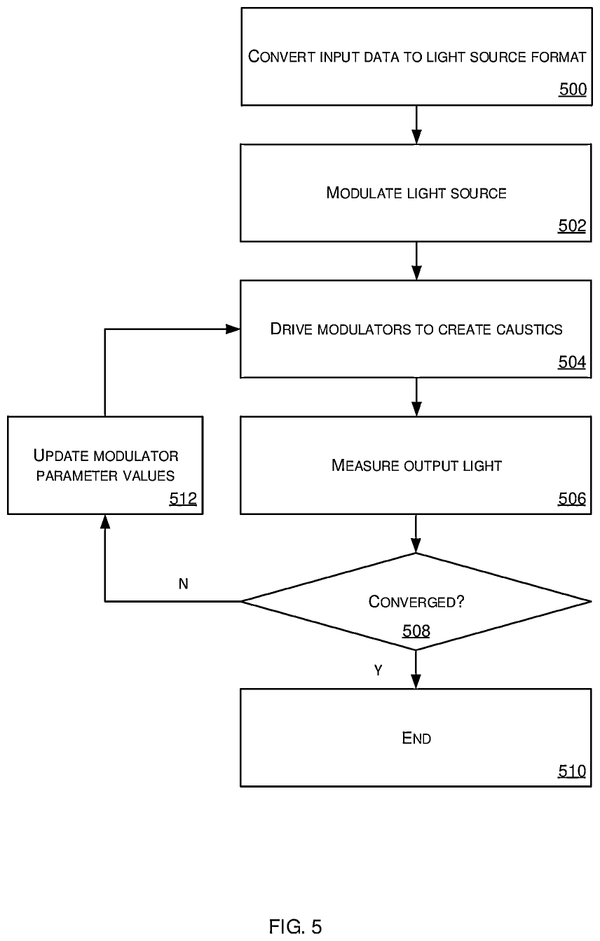

FIG. 5 is a flow diagram of a method of calibration of an optical computing device. Input data to be processed is converted 500 to a format suitable for input to an array of light sources. In an example, the input data is an image and the processing comprises downscaling the image to a same resolution as the resolution of the array of light sources. A range of intensity values of pixels of the downscaled image is then mapped to a range of intensity values of the light sources. Each light source is then arranged to emit light at an intensity related to the intensity of the corresponding pixel of the downscaled image. In another example the input data is text. The text is converted to one or more embedding vectors and each light source is arranged to emit light at an intensity related to a corresponding value in an embedding vector.

The light sources are optionally modulated 502 in some cases using frequency modulation or time division multiplexing as explained earlier in this document.

The controller 108 is used to drive 504 the modulators so that when the light from the light sources is modulated by the driven modulators caustic wavefronts are created. The caustic wavefronts experience constructive and/or destructive interference and then output light is generated. The output light is measured 506 using an image capture device or light meter and the measurements are sent to the controller 108.

The controller 108 checks if there is convergence 508 by checking whether the measurements are as expected. Since the controller knows the input data and knows how it drove the modulators it is able to compute expected measurements which result from the optical computation. If the measurements are within a threshold range of the expected measurements convergence has been reached. In this case the process ends 510 and values of parameters used to drive the modulators at operation 504 are saved. If convergence has not been reached the controller 108 updates the parameters values of the modulators 512 that it used when driving the modulators at operation 504. In this way the controller 108 becomes calibrated as it stores values of parameters to use for particular computations. In an example the controller is calibrated to drive the modulators to compute functions useful for neural networks such as rectilinear RELU transfer mode or non-linear Tan h.

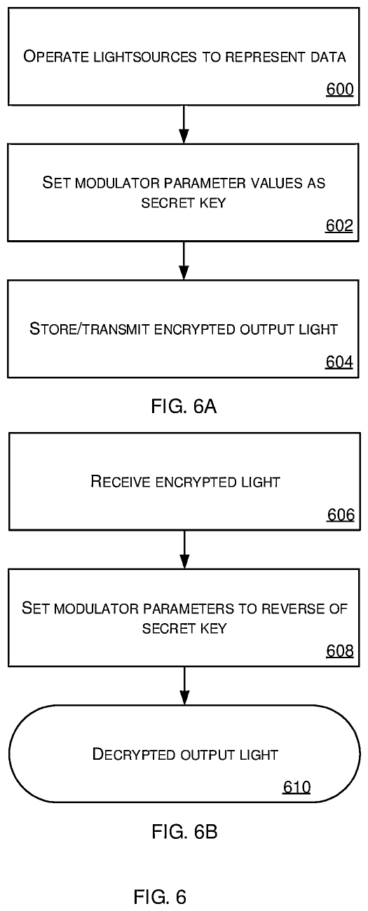

In an example described with reference to FIG. 6A and FIG. 6B the optical computing device 100 is used for encryption and decryption.

FIG. 6A is a flow diagram of a method of encrypting data using an optical computing device 100. Light sources are operated 600 to represent data to be encrypted. The controller 108 sets 602 values of parameters of the modulators. The values of the parameters are a secret key of a block cipher. The light is modulated using the modulators configured according to the parameter values and constructive and/or destructive interference of the caustic wavefronts occurs. The resulting output light is an encrypted version of the input data and is stored as an image or transmitted 604 to another entity in the form of light.

FIG. 6B is a flow diagram of a method of decrypting data using an optical computing device 100. The optical computing device 100 receives the encrypted version of the input data in the form of light. The optical computing device knows the secret key which is the values of the parameters of the modulators. It sets the modulator parameters to the secret key. The received light is passed into the modulators in a reverse direction to the direction used in FIG. 1 so that the caustic wavefronts undergo a reverse of the constructive and/or destructive interference. The light is output from the modulators and captured as an image. The captured image is then converted to digital data by reversing operation 500.

In an example the encryption comprises mixing an input array of plain text bits with a secret key, hence creating a new form of block cipher. The input plain text data is used to modulate the light sources, (in frequency or amplitude/intensity), while the secret key sets the modulator parameters. The final optical image output is then an encrypted copy of the input data.

To decode the result, the process is reversed. Hence, feed the output image back through system, and use the key to reverse the modulation effect sequence. By using N layers of modulators, an effect of having multiple block ciphers is given. As an encryption mechanism, this method is hardware based and computationally very efficient and fast. The result is resistant to attempts to break the encryption using known decryption methods. As the resulting cipher text data is a product of the hardware transforms, which are specific and unique to the particular hardware implementation. Caustic light rays can be emulated on a silicon graphics processing unit (GPU), but only at massive computational cost. An attacker would need to possess a copy of the original encrypting system to attempt to attack the code. An attacker also has to determine the secret keys used in each modulation layer.

In various examples the optical computation device is a hardware neural network. The examples of FIGS. 2 to 4 are hardware neural networks in some cases. Existing deep learning neural networks require extensive amounts of computing power, using GPUs, to achieve the learnt response. Using the technology described herein there is a hardware apparatus that computes neural network inference at optical speeds. Each layer of modulators forms a layer of an N layer neural network.

By using measurements from the CCD imager, the controller is able to apply adjustments to each filter, mimicking the back-propagation weight update method as used in classically implemented neural networks. In the case of supervised learning the controller is able to compute a loss function between the measurements observed from the CCD imager and ground truth values from labelled training data. The loss function is used to update the filter parameters so as to minimize the loss function.

Each modulator unit acts as a form of neuron, when the system is used as a neural network. The modulator acts on the light input, to both integrate the data (photon stream), and apply a transform function such as a Fourier Transform operation. These are the key functions of a standard neural network node in software. In some cases, the modulator transfer function is tuned to be linear, as in a rectilinear (RELU) transfer mode or non-linear (Tan h), as in common neural network designs.

By restricting the energy/intensity of each modulator output, using an electronic neutral density (ND) filter, a weighting value is applied to the output of each modulator. This weight adjustment is under the control of the controller 108.

The apparatus is used to implement any current neural network design, e.g. convolutional neural networks, and in addition may be used to build entirely new forms of neural processing architectures. For example, by combining a refractive and reflective modulator design, to create new neural topologies.

Also, by adding optical temporal loops, (using optic fibre coils), between the modulators, it is possible to add a memory function, and create a function similar to long-short term memory (LSTM) in standard neural models.

The controller 108 is a computing-based device and comprises one or more processors which are microprocessors, controllers or any other suitable type of processors for processing computer executable instructions to enable the controller to drive the modulators, compute updates for the filters, drive the filters, receive measurements from the output stage and carry out other tasks. In some examples, for example where a system on a chip architecture is used, the processors include one or more fixed function blocks (also referred to as accelerators) which implement a part of the method of the controller 108 in hardware (rather than software or firmware).

The computer executable instructions are provided using any computer-readable media that is accessible by computing based device. Computer-readable media includes, for example, computer storage media such as memory and communications media. Computer storage media, such as memory, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. An optical computing device comprising:
a plurality of light sources, each light source arranged to generate a photon stream, whereby the plurality of photon streams together represent a data input to be processed;
a plurality of modulators, each modulator arranged to modulate a photon stream received from one of the light sources, each modulator producing a caustic wavefront; and wherein the modulators are positioned relative to one another such that there is interference between the caustic wavefronts;
a controller for controlling the modulators in order to control the interference between the caustic wavefronts such that there is computation of the data input;
an output stage to output light resulting from the interference between the caustic wavefronts, the output light representing the result of optical computation of the data input.

2. The optical computing device of claim 1 wherein the modulators are controlled by a digital computer in order to control constructive and destructive interference between the caustic wavefronts such that there is computation of the data input.

3. The optical computing device of claim 1 wherein the output stage is configured to send feedback to the controller and where the controller takes into account, as part of controlling the modulators, one or more of: the feedback, time and a shape of a light caustic that evolves over time.

4. The optical computing device of claim 1 wherein the plurality of light sources are arranged in an array and the plurality of modulators are arranged in a corresponding array, and wherein the light sources are controllable to vary frequency and/or intensity of individual ones of the photon streams.

5. The optical computing device of claim 1 wherein the plurality of modulators is a first layer of modulators and wherein the optical computing device further comprises at least one further layer of modulators in series with the first layer of modulators, and wherein the further layer of modulators receives input comprising light from the first layer of modulators and produces output which is the output light.

6. The optical computing device of claim 5 further comprising a plurality of filter layers, and wherein the first layer of modulators and a corresponding filter layer computes a first layer of a neural network and each further layer of modulators and corresponding filter layer computes a further layer of a neural network; and where the filter layers are controllable by the controller in order to train the neural network.

7. The optical computing device of claim 1 wherein at least some of the modulators comprise refractive transparent material.

8. The optical computing device of claim 7 wherein the at least some modulators are one or more of: a liquid in a case driven to vibrate so as to set up standing waves in the liquid; a glass lens driven so that a relative position of the lens with respect to the light sources is changeable.

9. The optical computing device of claim 1 wherein at least some of the modulators comprise reflective surfaces.

10. The optical computing device of claim 9 wherein the at least some modulators are either a deformable reflective surface or a micro-mirror chip.

11. The optical computing device of claim 1 wherein at least some of the modulators are transparent liquid crystal displays configured to product a variable diffraction grating effect.

12. The optical computing device of claim 1 wherein the output stage comprises any one or more of: at least one image capture device to capture the output light; an optic fibre for transmitting the output light to another entity.

13. The optical computing device of claim 1 wherein the plurality of optical sources, comprises a first plurality of optical sources and a second plurality of optical sources; and wherein the plurality of modulators, comprises a first plurality of modulators in series with the first plurality of optical sources, and a second plurality of modulators in series with the second plurality of optical sources, such that in use, computation via the first plurality of modulators occurs in parallel with computation via the second plurality of modulators.

14. The optical computing device of claim 1 wherein the optical sources are pulsed and wherein the modulators are controlled taking into account a timing of the pulsed optical sources.

15. The optical computing device of claim 1 wherein the controller controls the modulators by setting values of parameters of the modulators and wherein the parameter values are a secret key of a block cipher such that the output light is an encrypted representation of the data input.
